(19) United States
(12) Patent Application Publication
(10) Pub. No.: US 2012/0159080 A1
(43) Pub. Date: Jun. 21, 2012

(54) NEIGHBOR CACHE DIRECTORY

(75) Inventors: Greggory D. Donley, San Jose, CA (US); William A. Hughes, San Jose, CA (US); Kevin M. Lepak, Austin, TX (US); Vydhyanathan Kalyanasundharam, San Jose, CA (US); Benjamin Tsien, Fremont, CA (US)

(73) Assignee: ADVANCED MICRO DEVICES, INC., Sunnyvale, CA (US)

(21) Appl. No.: 12/969,343

(22) Filed: Dec. 15, 2010

(51) Int. Cl. G06F 12/08

(52) U.S. Cl. 711/141; 711/E12.026

(57) ABSTRACT

A method and apparatus for utilizing a higher-level cache as a neighbor cache directory in a multi-processor system are provided. In the method and apparatus, when the data field of a portion or all of the cache is unused, a remaining portion of the cache is repurposed for usage as neighbor cache directory. The neighbor cache provides a pointer to another cache in the multi-processor system storing memory data. The neighbor cache directory can be searched in the same manner as a data cache.

### FIELD OF INVENTION

This application is related to processor cache technology.

### BACKGROUND

FIG. 1 shows a block diagram of an example of a multi-processor system 100. The multi-processor system 100 comprises multiple processing nodes 110_{A}-110_{D} (hereinafter collectively referred to by the numeral alone). Each processing node 110 is shown to comprise two processor cores 111_{A}-111_{D} (hereinafter collectively referred to by the numeral alone), where although two processor cores 111 are shown per processing node 110, a processing node 110 may comprise any number of processor cores.

The processor cores 111 may be any one of a variety of processors such as a central processing unit (CPU) or a graphics processing unit (GPU). For instance, they may be x86 microprocessors that implement x86 64-bit instruction set architecture and are used in desktops, laptops, servers, and superscalar computers, or they may be Advanced RISC (Reduced Instruction Set Computer) Machines (ARM) processors that are used in mobile phones or digital media players. Other embodiments of the processors are contemplated, such as Digital Signal Processors (DSP) that are particularly useful in the processing and implementation of algorithms related to digital signals, such as voice data and communication signals, and microcontrollers that are useful in consumer applications, such as printers and copy machines.

The processor cores 111 are computational centers responsible for performing a multitude of computational tasks that enable the multi-processor system 100 to operate. The processor cores 111 may include execution units that perform additions, subtractions, and shifting and rotating of binary digits, among many other computations and may also include address generation and load and store units that perform address calculations for memory addresses and the loading and storing of data from memory. The collection of these operations performed by the processor cores 111 drives computer applications to run.

The processor cores 111 may each have local caches 112_{A}-112_{D} (hereinafter collectively referred to my numeral alone), which are small storage spaces where commonly used instructions or data are placed. Local caches 112 are advantageous because of their close proximity to a processor core 111; a small memory access latency is experienced by a processor core 111 in obtaining instructions or data from a local cache 112. In many implementations, a processor core 111 seeking data will look to find the data in its local cache 112 before looking elsewhere in the memory hierarchy. However, because local caches are typically expensive to implement, they are limited to a small size. Examples of local caches 112 are Level 1 (L1) instruction or data caches.

In addition to having local caches 112, the processor cores 111 of multi-processor system 100 may also have shared caches 113 (hereinafter collectively referred to by numeral alone). A shared cache 113 is shared by the two processor cores 111 of a processing node 110 and is typically larger in size than the local caches 112. A shared cache 113 may be the next level in the memory hierarchy of the multi-processor system 100, such that the processor cores 111 may look to find data in the shared cache 113 of their “home” processing node 110 when it has been determined that their own local caches 112 do not contain the data. A shared cache 113 may be inclusive, meaning that the contents of the local caches 112 of the processor cores 111 are replicated in the shared cache 113. Conversely, a shared cache 113 may be an exclusive cache, meaning that data contained in the local caches 112 of the processor cores 111 is not necessarily contained in the shared cache 113. An example of a shared cache 113 is a Level 2 (L2) cache that is shared amongst the processor cores 111 of the processing node 110.

### SUMMARY OF EMBODIMENTS

Embodiments of a method and apparatus for repurposing a portion of a multi-processor system cache are provided. A first portion of a first cache is designated to hold pointer entries, where the pointer entries provide an indicator to a second cache that holds memory data requested from the first cache. Further, in the method and apparatus, a second portion of the first cache is designated to hold memory data entries that are accessed by a request to the first cache. In some embodiments, the first cache is a higher-level cache and the second cache is a lower-level cache.

In other embodiments, the pointer entries are held in a state field of the first cache and a data field associated with the state field is repurposed for storage, where the data field of the first cache that is repurposed for storage is used for probe filter storage. In yet other embodiments, the state field associated with the data field designated for holding memory data entries is used for a memory coherency protocol.

### BRIEF DESCRIPTION OF THE DRAWINGS

A more detailed understanding may be had from the following description, given by way of example in conjunction with the accompanying drawings wherein:

FIG. 1 shows an example of a multi-processor system;

FIG. 2 shows an example of a cache;

FIG. 3 shows an example of a cache search;

FIG. 4 shows an example of an n-way set-associative cache search;

FIG. 5 shows an example of an n-way set-associative cache with a repurposed data field;

FIG. 6 shows an example of a cache before and after repurposing a portion of its data; and

FIG. 7 shows an embodiment of an n-way set-associative cache with a neighbor cache directory.

### DETAILED DESCRIPTION

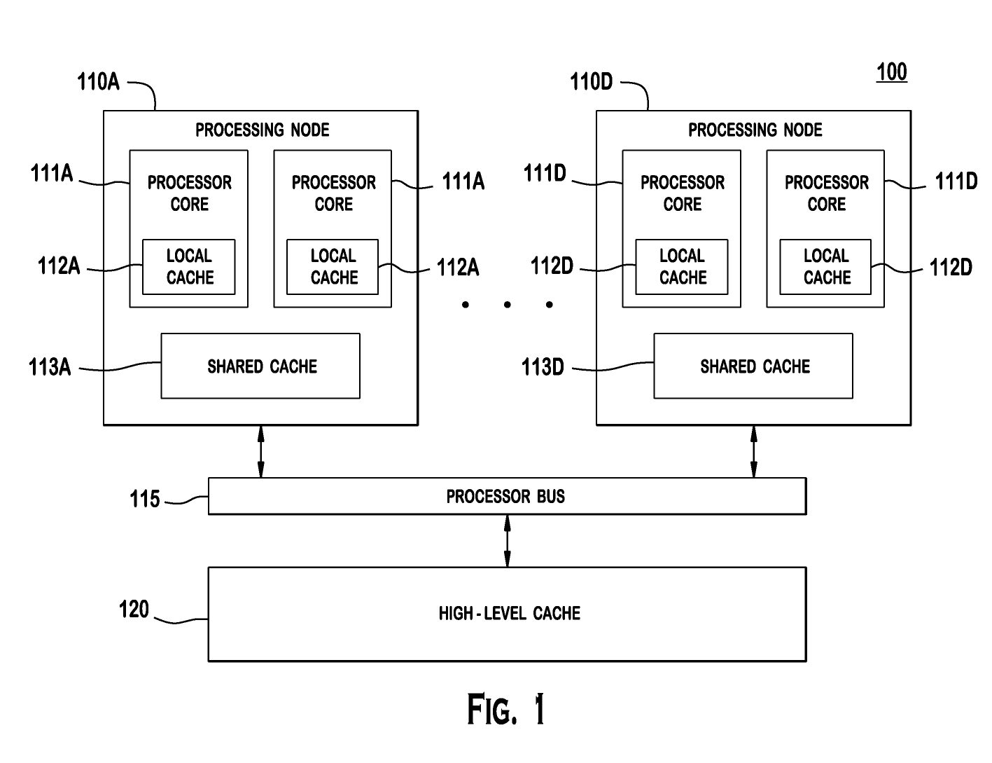

As seen in FIG. 1, the processing nodes 110 are connected via a processor bus 115 to a high-level cache 120, where in some multi-processor systems 100, the high-level cache 120 may reside on a chipset. The high-level cache 120 is shared among the processor cores 111 of all the processing nodes 110 and may be larger than either of the processing node 110 caches (i.e., local caches 112 and shared caches 113). Because the high-level cache 120 is not close to the processor cores 111, in a micro-architectural sense, a higher amount of delay is experienced by the processor cores 111 in obtaining data from the high-level cache 120 than when data is obtained from the local caches 112 and the shared caches 113. Typically, when a processor core 111 requires data, its local cache 112 is searched first and if the data is not found in the local cache the shared cache 113 is searched. If the data is not found in the shared cache 113, the high level cache 120 is searched and if the data is not found in the high-level cache 120, then a system's random access memory (RAM) is searched.

Like a shared cache 113, the high level cache 120 may be exclusive, such that it does not contain the data stored in the shared caches 113. The high level cache 120 may, alternatively, be inclusive, such that it contains the data stored in the shared caches 113 of the processing nodes 110. However, inclusiveness may limit the effectiveness of the high level cache 120, where, for instance, half of an 8 Mega Byte (MB) high level cache 120 may be dedicated to replicating the data of the shared caches 113 of the four processing nodes 110, each of a 1 MB size. In that instance, only 4 MB would be left for caching purposes in the high-level cache 120. Therefore, more of the resources of a high-level cache 120 may be available when the cache is exclusive and it does not replicate the data stored in lower-level caches.

As mentioned previously, caching is useful for keeping a copy of system memory data (where system memory may include RAM or hard disk memory) close by to the processor cores 111 for ease of access. A processor core 111 can access data that is present in its caches (local cache 112, shared cache 113, or high level cache 120) faster than it can access data from its RAM. Therefore, caching may reduce memory access latency and result in faster execution of computational tasks by the multi-processor system 100, since the processor cores 111 may not have to wait as long for needed data to be brought to them.

Data in the system memory and local caches of a multi-processor system 100 is referenced by memory addresses, where a processor core 111 seeking memory data sends a request asking for memory data residing in a specific memory address. Memory addresses may have any number of bits, where for instance, in some implementation 48 bits are used to index a byte or an octet in memory. When a processor core 11 requires data, it sends out a request that includes the memory address for the needed data. The hierarchy of caches—local caches 112, shared cache 113, and the high level cache 120—are searched, and if they do not contain the data for the requested memory address, then system memory is searched. Because data is requested according to its memory address, caches are structured to utilize memory addressing in order for fast searching to be performed.

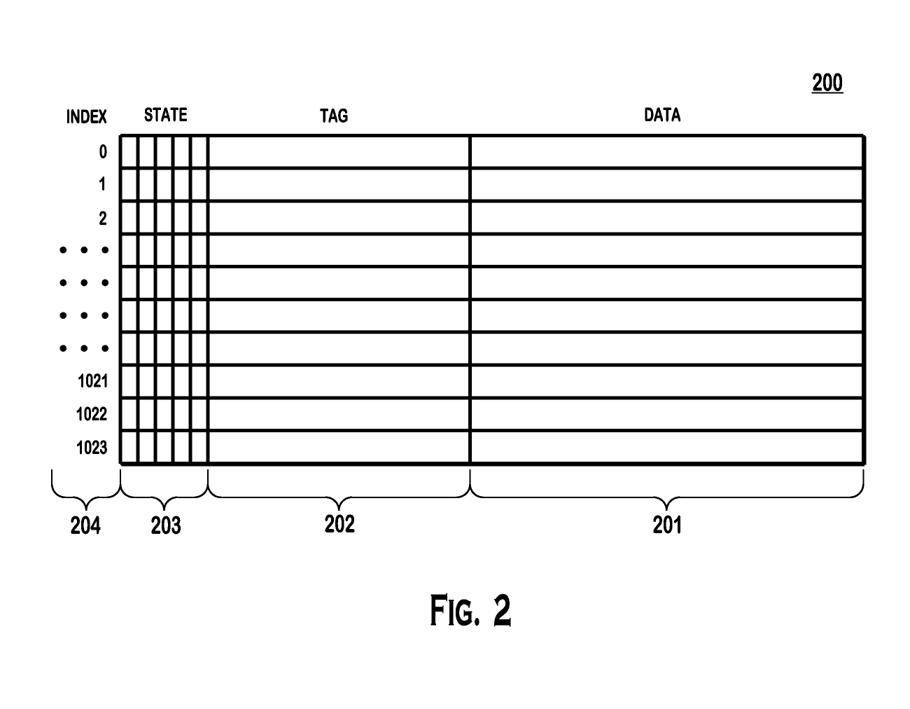

FIG. 2 shows an example of a cache 200. In the cache 200 data is stored in a data field 201, also referred to as a cache line, which may contain any number of bytes. The number of bytes in a data field 201 is usually a power of 2 so that each byte within one data field 201 may be efficiently indexed and referenced using a certain number of bits. For instance a cache 200 with an 8-byte data field 201 requires 3 bits for referencing each of the 8 bytes.

The cache 200 also has a state field 203 for every data field 201. The state field 203 may be any number of bits but usually comprises several bits that give indications about the state of the data within the corresponding data field 201. One of these state bits may be a valid bit, for instance, that indicates whether the data in the data field 201 is valid. If the valid bit of the state field 203 indicates that the data in a data field 201 is valid, then the data can be outputted and used. Alternatively, if the valid bit of the state field 203 indicates that the data in a data field 201 is invalid, the data may not be outputted when requested. Further, some bits of the state field 203 may be used to maintain cache coherence information regarding data. Cache coherence, which will be discussed in further detail herein, is important in multi-processor systems, such as multi-processor system 100, where copies of memory data are commonly held in different processor core caches (such as local caches 112) and are written to or modified in these caches by processor cores 111. Cache coherence is the process of updating other caches in a multi-processor system with the up-to-date information regarding data. For instance, when two processor cores 111 have copies of the same memory data in their respective local caches 112, and one processor core 111 operates on the data and changes it, through cache coherency the other processor core 111 whose local cache 112 holds the data is informed of the changes and may therefore label its own version of the data as no longer valid.

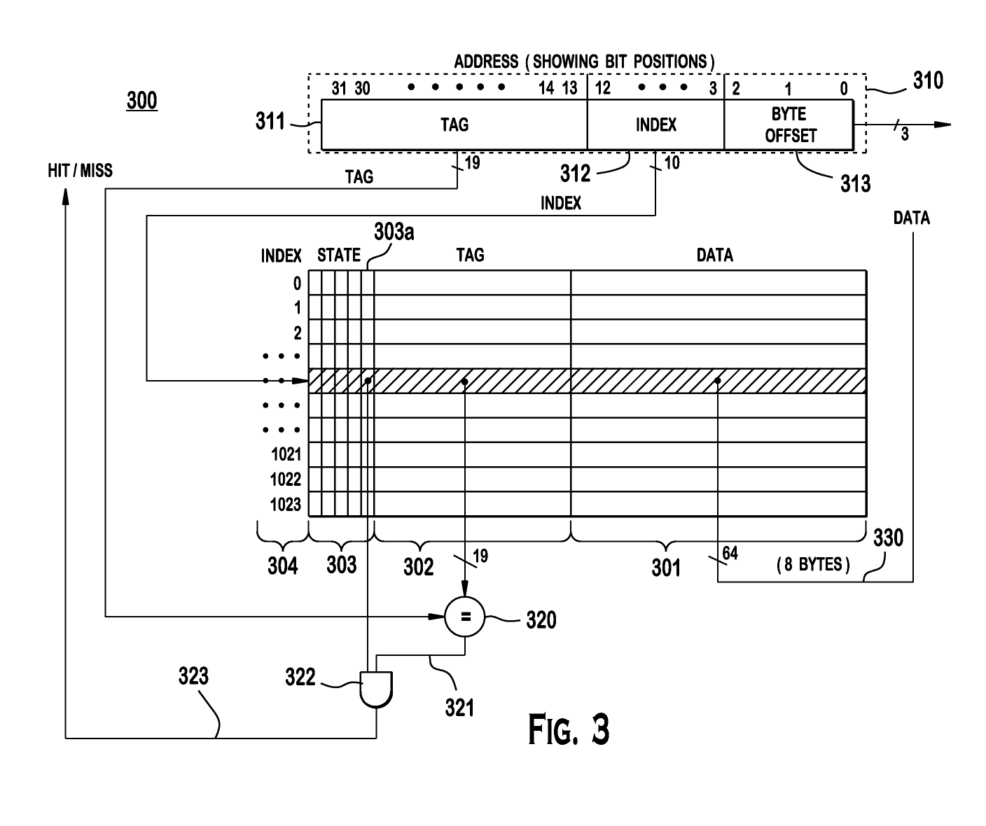

Cache 200 also has two memory address-related components: an index 204, comprised of index entries, and a tag field 202. The index 204 and tag field 202 are both drawn from the memory address of the data that is stored in the cache 200. The index 204 of cache 200 is 1024 in length, and it may be referenced using 10 bits. Each data field 201 has a corresponding entry in the index 204. For instance, if a data field 201 of cache 200 contained 8 bytes of data, then the cache 200 would be (1024)*8 bytes in size, or 8 kilo bytes (kB). The tag field 202 is also used for memory addressing purposes, as will be shown in more detail in FIG. 3.

FIG. 3 shows an example of reading data from a cache 300. This cache's 300 data is held in data fields 301, with corresponding state fields 303 and tag fields 302. The cache 300 also has an index 304 comprised of 1024 index entries corresponding to the data fields 301. Cache 300 is 1024 (1k) data fields 301 in size. In the example shown in FIG. 3, a request for data in a memory address 310 is received by the cache 300. The memory address 310 is 32 bits in length, of which 19 bits are for the tag 311, 10 bits are for the index 312, and 3 bits are for the byte offset 313.

Because cache 300 has an index 304 of size 1024 (which may be fully referenced using 10 bits), the 10-bits in the memory address 310 making up the index 312 are used to point to the appropriate index entry of index 304 of the cache 300. After the index 312 of the memory address 310 is used to point to the appropriate index entry of index 304 in the cache 300, the tag 311 of the memory address 310 is compared against the corresponding tag field 302. If the tag 311 of the memory address 310 matches the tag field 302, this indicates that the requested data is contained in the corresponding data field 301. However, if the address tag 311 does not match the tag field 302, then this indicates that the data contained in the data field 301 is not that of the requested memory address 310.

Equator 320 is used to determine if the tag 311 of memory address 310 matches the tag field 302 corresponding to the index entry that matched the index 312. If there is a match, then line 321 is asserted (with an output of 1) and vise-versa. However, even if the data for the requested address is contained in a data field 301, it may or may not be valid. For instance, the data may not be current or may have been subsequently overwritten. To account for these possibilities, the state field 303 has a valid state 303a, where if the valid state is asserted (with an output of 1), then it is implied that the data is valid and vise-versa. Thereafter, the logical conjunction (using AND gate 322) of the valid bit 303a of the state field 303 and the output 321 of equator 320 is taken to indicate a cache “hit” when it is asserted (with an output of 1) and a cache “miss” when it is not asserted (with an output of 0). When there is a cache hit, the data in the indicated data field 301 of the cache 300 is outputted 330. As previously mentioned, the outputted data 330 is 8 bytes in size. The byte offset 313 indicates the byte position of the needed data in a data field 301. For instance, 000 may indicate that the requested memory address 310 is the first byte in a data field 301, whereas 111 may indicate the requested memory address 310 is the last byte in a data field 301. Thereby, the byte offset 313 of the memory address 310 is used to select the requested byte.

Those skilled in the art will recognize that cache 300 is a directly-mapped cache because any two memory addresses that share an address index, such as address index 312, will only be mapped to one location in the cache 300—the location pertaining to the matching index entry of index 304. A cache may, on the other hand, be set-associative, which implies that memory addresses that share an index may be mapped to more than one location in the cache. Caches may be associative in any number of ways. For instance, a cache may be 2, 4, 8, 16, or 32-way set-associative. The number of ways indicates the number of possible places in the cache that a certain memory address may belong.

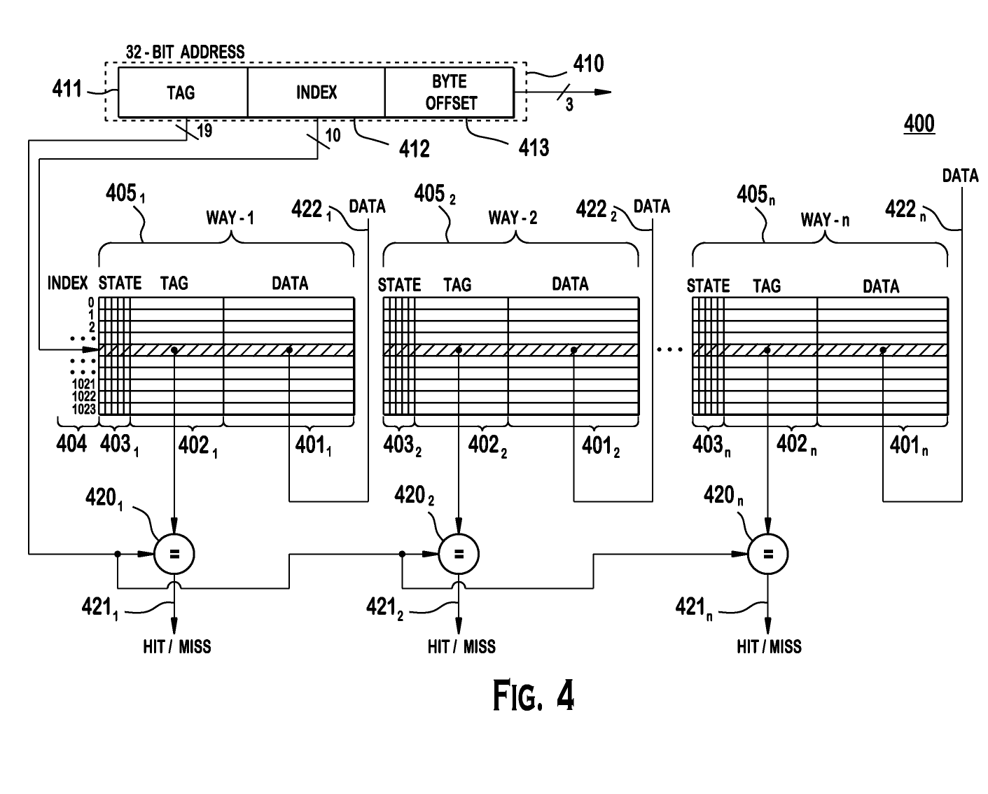

FIG. 4 shows an n-way set-associative cache 400 and an incoming memory address 410 being read from the cache. The memory address 410 is 32-bits in length and it is comprised of a tag 411 that is shown to be 19 bits in length, an index 412 that is shown to be 10 bits in length, and a byte offset 413 that is shown to be 3 bits in length. The length of the memory address 410 and its associated segmentation is shown for illustrative purposes and those skilled in the art will recognize that any number of bits may be used for a memory address which can, in turn, be segmented any number of ways without deviating from the scope of the invention disclosed herein. The same applies to the size of the cache or its segmentations.

The cache 400 shown in FIG. 4 is n-way associative where n represents the set-associativity of the cache and may range from one (where the cache is said to be directly mapped) to m (where the cache is said to be fully associative). Way-0 405₀ and way-n 405ₙ are shown in FIG. 4. Each way 405 (collectively hereinafter referred to by the numeral alone) has a data field 401, a tag field 402, and a state field 403. The index 404 of the cache 400 has 1024 index entries. The index may be any number of entries, however.

The state field 403 may comprise any number of bits, where some of these bits may be used for the purposes of cache coherency. Some state fields may follow the MOESI (modified, owned, exclusive, shared, invalid) coherency protocol. Table 1 shows the meaning of the states of the MOESI protocol.

TABLE 1
MOESI cache coherency states

| State | Interpretation |
|---|---|
| Invalid | A cache line in the invalid state does not hold a valid |
| | copy of the data. Valid copies of the data can be either |
| | in main memory or another processor cache. |
| Exclusive | A cache line in the exclusive state holds the most recent, |
| | correct copy of the data. The copy in main memory is also |
| | the most recent, correct copy of the data. No other |
| | processor holds a copy of the data. |
| Shared | A cache line in the shared state holds the most recent, |
| | correct copy of the data. Other processors in the system |
| | may hold copies of the data in the shared state, as well. |
| | If no other processor holds it in the owned state, then |
| | the copy in main memory is also the most recent. |
| Modified | A cache line in the modified state holds the most recent, |
| | correct copy of the data. The copy in main memory is |
| | stale (incorrect), and no other processor holds a copy. |
| Owned | A cache line in the owned state holds the most recent, |
| | correct copy of the data. The owned state is similar to |
| | the shared state in that other processors can hold a |
| | copy of the most recent, correct data. Unlike the shared |
| | state, however, the copy in main memory can be stale |
| | (incorrect). Only one processor can hold the data in the |
| | owned state-all other processors must hold the data in |
| | the shared state. |

In some embodiments, three of the state field bits may be used to indicate an MOESI state, where 3′b0xx=Invalid, 3′b100=Exclusive, 3′101=Shared, 3′b110=Modified and 3′b111=Owned. Further, some of the state bits may indicate a core that originally placed the data in the cache.

When a data request for a memory address 410 is received, in order to determine whether the data pertaining to the memory address is present in cache 400, the index 412 of the memory address is used to point to the proper index entry in the index 404 of the cache 400 where the data may be held. Because cache 400 is n-way set associative, the index 412 points to the data being present in any of the data fields 401 of the n-ways 405 of the cache 400 having the same index entry in index 404 as the memory address index 412. To determine whether the data resides in the cache, all n tag fields 402₀-402ₙ are compared to the address tag 411 to determine whether there is a match. This comparison is done using equators 420₀-420ₙ. If any of the tag fields 402 match the address tag 412, then a hit is declared and the corresponding line 421₀-421ₙ is asserted (with an output of 1) and the corresponding data is outputted 422 from the data field 401. However, if the tag 411 of the address does not match the tag field 402 of any of the n-ways at the particular index entry in index 404, then it is determined that the cache 400 does not hold the needed data and a cache miss is declared.

The state field 403 pertaining to the outputted data 422 is used to identify whether the data is valid or current, where, for instance, if the invalid bit is asserted the data may be deemed to be not useful and may, therefore, not be subsequently used. If the exclusive bit of the state field 403 is asserted, then it is implied that the cache holds the most recent, correct copy of the data, where the copy in main memory is also the most recent, correct copy of the data and no other processor holds a copy of the data. Table 1 may be used to determine the meaning of the remaining states, if an MOESI protocol is used for the state field 403. Additionally, a cache may also use other coherency protocols for the state field 403 that are well known to those skilled in the art.

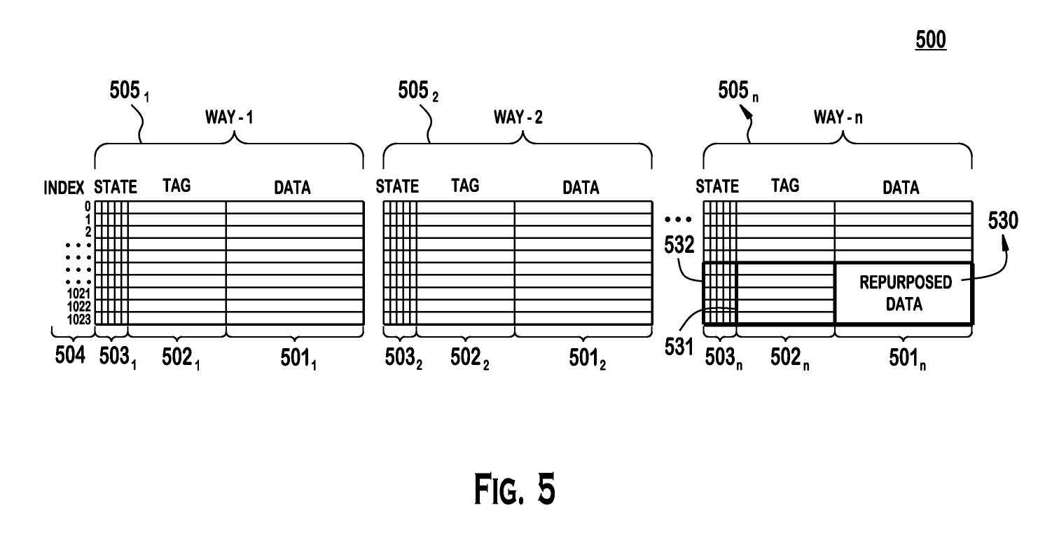

In some embodiments, the portions of a cache containing data fields are re-designated for purposes other than the storage of cache data. FIG. 5 shows an embodiment of an n-way set associative cache 500. The cache 500 has data fields 501, corresponding state fields 503 and tag fields 502, and an index 504 comprised of index entries for each of its n-ways 505. A portion of the cache 500 designated for data fields 501, of way-n 505ₙ has been repurposed, where in FIG. 5 it is shown as repurposed data 530. The repurposed data 530 takes up a portion of the cache 500 designated for data fields 501, however, the portion of the cache 500 designated for the corresponding tag fields 502 and state fields 503 remains unused, because only data storage is needed; tag and state information about the repurposed data 530 is not needed for the application to which the repurposed data 530 is needed. In FIG. 5, the unused tag field and state field portions of the cache 500 associated with the repurposed data 530 are labeled tag field 531 and state field 532, respectively.

An example of an application that may use re-designated or repurposed data is a probe filter, which is also known as a snoop filter or a memory coherency filter. A probe filter requires data storage space, such as the repurposed data 530 field, for minimizing memory coherency traffic in a multi-processor system. As mentioned previously, memory coherency is important in multi-processor systems, like multi-processor system 100 in FIG. 1, where multiple processor cores 111 may operate on memory data and may each have different versions of this data in their local caches 112. For instance, it may occur that two processor cores 111 maintain in their local caches 112 a copy of the same memory value and one of these cores may write over this data and store the result in its own local cache 112. In this instance, the other core's local cache 112 and the system memory will have stale copies. To counteract this, the other core's local cache 112 or the main memory may snoop or probe the cache 112 to determine whether their own copies of the data are stale or invalid. This process of probing creates a lot of traffic amongst the various processor cores 111 in multi-processor system similar to system 100. To reduce this traffic, many multi-processor systems employ a probe filter. The purpose of the probe filter is to minimize probing traffic between various processor core caches. The probe filter requires storage space for data, like the repurposed data 530 of the cache 500 in FIG. 5, but does not require the state field 532 or the tag field 531 associated with this data. Other applications that require storage space for data but do not require corresponding state and tag information are also contemplated.

Rather than wasting the tag field 531 and the state field 532 associated with the repurposed data 530 of the cache 500, these fields may be utilized in a multi-processor system for a neighbor cache directory. A neighbor cache directory provides an indication to a processor core of whether requested data may be present in another processor core's cache. Therefore, rather than obtaining data from system memory, such as RAM, data may be obtained from a neighbor core's cache.

Returning to FIG. 1, in the instance that one of the processor cores 111_{A} of processing node 110_{A} requires data to operate on, its local cache 112_{A} will be searched. If the data is not found in its local cache 112_{A}, then its shared cache 113_{A} is searched. If the data is not found there, then the high-level cache 120 that all processor cores 111_{A}-111_{D} share is searched. If the data is not found in the high-level cache 120, then system memory is searched, but there is generally a larger amount of delay experienced in obtaining data from system memory than in obtaining data from the caches.

In many instances, the data requested by a processor core 111_{A} may be present in the local caches 112 or shared cache 113 of a processing node other than the home node (e.g. processing node 110_{D}). For instance, the shared cache 113_{D} of processing node 110_{D} may hold a copy of the requested memory data. Therefore, a processor core 111_{A} may rather obtain the requested data from the shared cache 113_{D} of processor node 110_{D} than obtain the data from system memory, as there may be a smaller amount of latency in obtaining the data from the neighbor cache (i.e., shared cache 113_{D}) than from the system memory.

A neighbor cache directory utilizes the unused state and tag fields of repurposed data to hold information regarding whether data requested from the cache is present in other caches in a multi-processor system. The portion of a cache designated for state fields corresponding to repurposed data may itself be repurposed to include a pointer that indicates that another core's cache holds the requested data. The repurposing of the portion of the cache designated for state fields is possible because with the data field being repurposed, these state fields are otherwise unused.

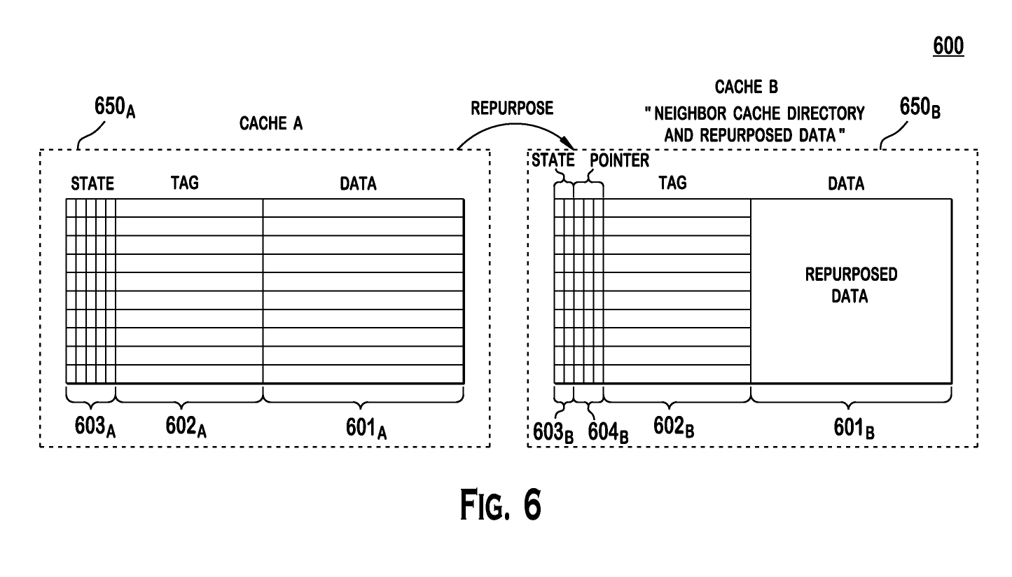

FIG. 6 shows an example of repurposing a cache when the data portion of a cache is dedicated to purposes other than storage of cache data. Cache A 650_{A} is a conventional cache with a data field 601_{A}, tag field 602_{A}, and a state field 603_{A}. Cache A 650_{A} may be repurposed into cache B 650_{B}. Cache B 650_{B} has a data field 601_{A} that has been repurposed, for instance as a storage space for a probe filter. However, rather than wasting the remaining fields of cache B 650_{B}, they are repurposed for a neighbor cache directory. While cache B 650_{B} may no longer be searched for cache data because its data portion has been repurposed, the state and tag field portions that have been repurposed as a neighbor cache directory may be searched to determine whether a requested data address is present in another cache in the memory hierarchy. The tag fields 602_{B} of cache B 650_{B} may still be used for holding memory address tags, but not the tags corresponding to the repurposed data. Rather, the tag fields 602_{B} of cache B 650_{B} hold memory address tags relating to whether and where a memory address may be stored in other neighboring caches. Additionally, in cache B 650_{B}, the state field 603_{A} of cache A 650_{A} may be repurposed into a state field 603_{B} and a new pointer field 604_{B}. The state field 603_{B} of cache B 650_{B} is used to hold necessary state information. The pointer field 604_{B} of cache B 650_{B} (which is a repurposed portion of the state field 603_{A} of cache A 650_{A}) is used to indicate where elsewhere in other caches the data may be held.

For instance, the pointer field 604_{B} may be a 3-bit field (000 to 111) that points to a neighbor cache having a copy of the requested memory address. In this example, the repurposed pointer field 604_{B} can point to any one of eight neighbor caches. When this information is provided, the data may be fetched to the requesting core from a neighbor cache as opposed to being fetching from system memory.

The state field 603_{B} of cache B may use a sub-set of the states used by cache A 650_{A}. Further, these states may have a different meaning or the same meaning. For instance, cache B 650_{B} may use the MOESI modified state to indicate that the data is in the MOESI modified in the neighbor core's cache.

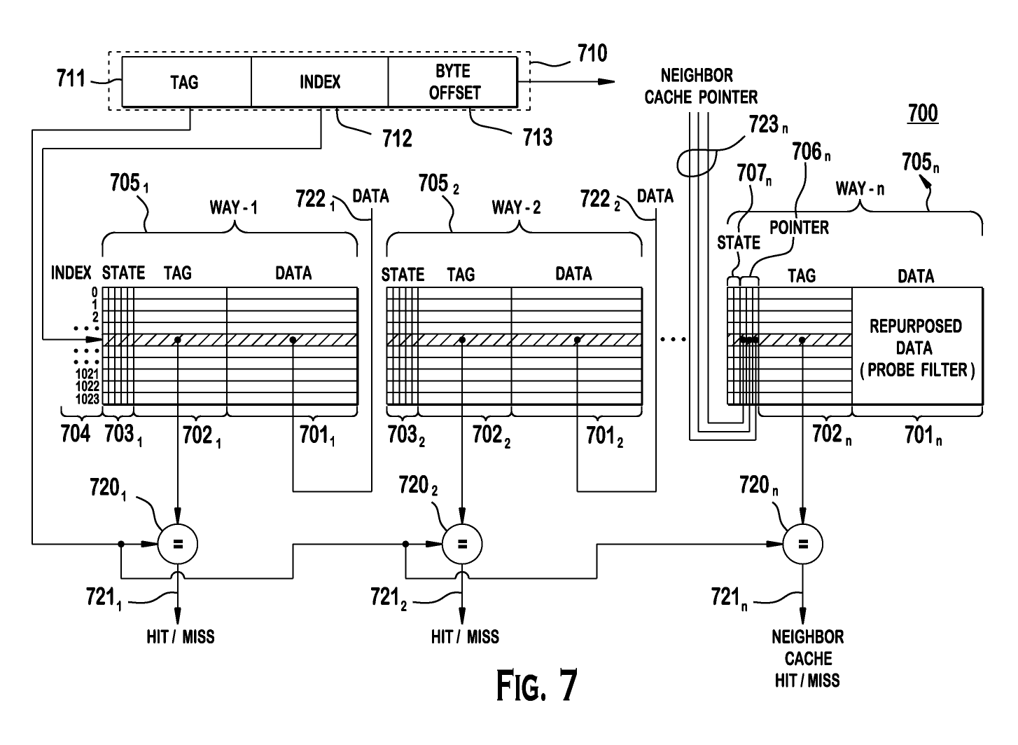

FIG. 7 shows an embodiment of a cache 700 including a neighbor cache directory. This cache 700 may be a higher-level cache in a multi-processor system, where there may be lower-level caches or local caches also in the system. For instance, this cache may be an L3 cache in a system also comprising L1 or L2 caches. The cache 700 is provided with a request for memory address 710 data. The memory address 710 request may come from a processor core and may have resulted in a lower level cache miss in the core's own memory access hierarchy. The cache 700 may or may not contain the requested data from the core and depending on the state of the data in the cache 700, the cache may or may not have a valid copy of the data. However, since the cache 700 is equipped with a neighbor cache directory, it can indicate whether the data exists in another cache in the multi-processor system (i.e. a lower level cache of another processor core).

The received memory address 710 comprises a tag 711, an index 712, and a byte offset 713. The cache 700 is n-way set associative, where the portion of the cache 700 designated for data fields 701ₙ of way-n 705ₙ has been repurposed to be a probe filter for the minimization of cache coherency traffic. Although the entirety of the portion of cache 700 designated for way-n 705ₙ data fields 701ₙ is taken up by the probe filter in this embodiment, in other embodiments the repurposed data may take up the data fields 701 associated with more than one of the ways 705 of the cache 700, or may take up portions of one or more ways 705. For instance, the repurposed data 530 in FIG. 5 is shown to take up a portion of the area designated for the data fields 501ₙ of way-n 505ₙ.

Way-0 705₀ through way-(n−1) 705ₙ₋₁ of the cache 700 are used for conventional caching purposes and each have data fields 701, tag fields 702, state fields 703, and an index 704. The index 712 of the requested memory address 710 is used to point to a corresponding entry in the index 704. Thereafter, the tag fields 702 of all the n ways 705₀-705ₙ₋₁ corresponding to the matched index entry are compared using equator 720 with the tag 711 of the received memory address 710. If a match exists on any of the portions of the cache containing data (way-0 705₀ through way-(n−1) 705ₙ₋₁, in this embodiment) then a cache hit is declared and the corresponding cache hit/miss line 721₀-721ₙ₋₁ is asserted. Thereafter, the data corresponding to the matching tag field is outputted 722 and the processor core need for data is, therefore, satisfied. The state field 703₀-703ₙ₋₁ indicates the state of the matched data, and may be according to any one of the memory coherency protocols (MOESI, for instance). If a cache miss is declared then no data may be outputted and the processor core's need for data is not met. The core will likely need to request the data from system memory, or if this cache 700 is not the highest level cache in the multi-processor system's memory hierarchy, then the data may be requested from a higher level cache. However, because this cache also comprises a repurposed neighbor cache directory, it may yield a neighbor cache directory hit and the memory data may be requested from a neighbor core's cache that has the desired data.

The neighbor cache directory is searched in the same manner as that of a conventional cache search described herein. The index 712 of the memory address 710 points to an entry in the index 704 where tags are to be compared. Thereafter, the memory address 710 tag 711 is compared (using equator 720ₙ) to the tag field 702ₙ of the matching index entry. If there is a match corresponding to the neighbor cache directory, then the neighbor cache hit/miss line 721ₙ is asserted (with an output of 1) to indicate a neighbor cache hit. Because the match was in a region of the cache whose data fields 701ₙ have been repurposed, no data is outputted. Instead, since this region of the cache represents the neighbor cache directory, the pointer field 706ₙ is outputted. The outputted neighbor cache pointer 723ₙ indicates another cache location in the system where the requested data is present. The neighbor cache pointer 723ₙ may be used to obtain the requested data from another cache in the system. For instance, a memory controller may use the pointer to provide the data to the requesting core from another core's cache. The state field 707ₙ of the neighbor cache directory may be used to maintain information regarding the neighbor cache.

In some embodiments, a cache including a neighbor cache directory may be a higher level “victim” cache, where data evicted or removed (i.e., due to lack of capacity) from lower-level caches is stored. Further, as previously mentioned, a cache with a neighbor cache directory may be the highest level cache in a multi-processor system's memory access hierarchy.

The memory addresses that are held in a neighbor cache directory, i.e. neighbor cache directory entries, may be populated in a variety of ways that are intended to make the memory hierarchy of a multi-processor system more efficient. Memory access data that is most likely to be shared among processor cores may be important to include in a neighbor cache directory. Communication data between processor cores is one type of data that is commonly read and modified by these cores and copies of the data are maintained in the cores' lower-level caches. It would therefore be useful to include entries for this data in the neighbor cache directory so that a requesting core may take advantage of the neighbor cache and be able to access this data with lower latency.

In other embodiments, a higher-level cache with a neighbor cache directory may receive a request for data that is in the modified state (i.e., the cache holds the most recent, correct copy of the data, the copy in main memory is stale (incorrect), and no other processor holds a copy). If the data were to be given to the processor core and removed from the higher level cache, then it may be useful to include it in the neighbor cache directory and provide a pointer to the requesting core's cache.

Further, a neighbor cache entry may be updated because of a neighbor cache hit. For instance, when one core requests data from a high-level cache with a neighbor cache directory and the request results in a neighbor cache hit, then a pointer is provided to point to a core whose cache has the data. In this instance, the requested data will be delivered to the requesting core from the other core's cache and the requesting core may keep the data in its own cache. Therefore, it is useful for the neighbor cache entry to be updated in order to point to the cache of the requesting core since this core having requested the data may now operate on and change the data.

In some embodiments memory address data that is present in the cache may be removed from the neighbor cache directory, as it is redundant to maintain memory data in the cache and also maintain an entry for a pointer to a lower-level cache containing the same data. Furthermore, in some embodiments, if a lower-level cache evicts data that is pointed to by the neighbor cache directory, the neighbor cache entry may be removed and the data may be placed in the high-level cache instead.

In other embodiment, when a core requests data and this data is provided to the core from outside the core's own multi-processor system memory hierarchy (such as another multi-processor system's caches), it is useful for the neighbor cache directory to be updated to include a pointer to the requesting core's cache that now holds the data. This data may now also be requested by other cores in the multi-processor system and a neighbor cache directory entry to the requesting core which now holds the data is beneficial to the operation of the multi-processor system. It is worth noting that a neighbor cache directory may only point to cache's within its own hierarchy and may therefore not point to cache's of a multi-processor system outside its own hierarchy. However, in the event that a requesting core receives data from outside its own multi-processor hierarchy, then, as previously mentioned, the neighbor cache may be updated to include a pointer to this received data.

In some embodiments, a processor core may have data in its local caches that other processor cores also have in their local caches in the shared state. As described in Table 1, a cache line in the shared state holds the most recent, correct copy of the data. Other processors in the system may hold copies of the data in the shared state, as well. If no other processor holds it in the owned state, then the copy in main memory is also the most recent. A core may wish to modify its data and may issue a request to other processor cores to render their own copies invalid. In this instance, it is useful for a neighbor cache directory to have an entry to point to the processor core's cache now modifying the data. It is worth noting that a core's request to invalidate the data in other cores' caches may sometimes fail, i.e., when there are other processor cores also attempting the same. It is, therefore, useful to only install a neighbor cache directory entry when the request does not fail.

As previously discussed, because communication data is shared amongst processor cores, they are good candidates for installation in the neighbor cache directory. Communication data may be data that results in a hit in other cores' caches in the system. Non-communication data, on the other hand, may be provided to a core from system memory. However, a neighbor cache directory may have entries to either type of data or both types of data, where an insertion algorithm may be utilized to determine which type of data to install in the neighbor cache directory.

In other embodiments, entries in the neighbor cache directory are not installed when there are indications that data is not being shared by multiple cores. For instance, when one processor cores installs data in a high-level cache and thereafter requests this data, in some embodiments, this data may not be installed in the neighbor cache directory as it was not shared by another core and may, therefore, not be a good candidate for sharing among other cores.

Although features and elements are described above in particular combinations, each feature or element may be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of processors, one or more processors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions (such instructions capable of being stored on a computer readable media). The results of such processing may be maskworks that are then used in a semiconductor manufacturing process to manufacture a processor which implements aspects of the present invention.

What is claimed is:

1. A method utilizing an originally purposed cache comprising:
configuring a first portion of a first cache to hold pointer entries, wherein the pointer entries provide an indicator to a second cache, the second cache storing memory data requested from the first cache; and
configuring a second portion of the first cache to store memory data entries, wherein the memory data entries are accessed by a request to the first cache.

2. The method of claim 1 further comprising
receiving a request for memory data; and
outputting at least one of the requested memory data or a pointer to the second cache storing the requested memory data.

3. The method of claim 1, wherein the pointer entries are held in a state field of the first cache and a data field associated with the state field is repurposed for storage.

4. The method of claim 3, wherein the data field of the first cache also is used for probe filter storage.

5. The method of claim 1, wherein the state field also is used for memory coherency protocol information.

6. The method of claim 1, wherein the first cache is a higher-level cache and the second cache is a lower-level cache.

7. The method of claim 1, wherein data held in the second cache is accessed by a processor core with less latency than if the data were to accessed from system memory.

8. The method of claim 1, wherein the first and second portions of the first cache are searched in parallel.

9. The method of claim 1, wherein an insertion algorithm is utilized to determine which type of data to install in the neighbor cache directory.

10. A processing system comprising:
a first cache comprising:
circuitry configured as pointer entries, wherein the pointer entries provide an indicator to a second cache, the second cache storing memory data requested from the first cache; and
circuitry configured as memory data entries, wherein the memory data entries are accessed by a request to the first cache.

11. The processing system of claim 10 further comprising circuitry configured to receive a request for memory data and output at least one of the requested memory data or a pointer to the second cache storing the requested memory data.

12. The processing system of claim 10, wherein the pointer entries are held in a state field of the first cache and a data field associated with the state field is repurposed for storage.

13. The processing of claim 12, wherein the data field of the first cache also is used for probe filter storage.

14. The processing of claim 10, wherein the state field also is used for memory coherency protocol information.

15. The processing of claim 10, wherein the cache is a higher-level cache and the second cache is a lower-level cache.

16. The processing system of claim 10, wherein data held in the second cache is accessed by a processor core with less latency than if the data were to accessed from system memory.

17. The method of claim 10, wherein the first and second portions of the first cache are searched in parallel.

18. The method of claim 10, wherein an insertion algorithm is utilized to determine which type of data to install in the neighbor cache directory.

19. A computer-readable storage medium storing a set of instructions for execution by one or more processors to facilitate manufacture of a cache, the cache comprising:
a configuring code segment for configuring a first portion of a first cache to hold pointer entries, wherein the pointer entries provide an indicator to a second cache, the second cache storing memory data requested from the first cache; and
a configuring code segment for configuring a second portion of the first cache to store memory data entries, wherein the memory data entries are accessed by a request to the first cache.

20. The computer readable storage medium of claim 19, wherein the set of instructions are hardware description language (HDL) instructions used for the manufacture of a device.
